(19) United States
(12) Patent Application Publication
(10) Pub. No.: US 2022/0120449 A1
(43) Pub. Date: Apr. 21, 2022

(54) DYNAMIC DATA COLLECTION FOR HEATING APPLIANCES

(71) Applicant: A. O. SMITH CORPORATION, Milwaukee, WI (US)

(72) Inventors: Ronald Paul Bartos, West Bend, WI (US); Brian Thomas Branecky, Oconomowoc, WI (US); Yaojun Wang, Sussex, WI (US)

(21) Appl. No.: 17/073,665

(22) Filed: Oct. 19, 2020

(51) Int. Cl. F24D 19/10; F24D 17/00; G06F 16/907

(52) U.S. Cl. CPC F24D 19/1051; G06F 16/907; F24D 17/0036

(57) ABSTRACT

Systems and methods for dynamically collecting data from water heating appliances. A water heating system comprises a water heating appliance. The water heating appliance includes a controller having an electronic processor. The controller is configured to receive, in response to the water heating appliance being in a first operating mode, operational data of the water heating appliance at a first sampling rate. The controller is further configured to receive, in response to the water heating appliance being in a second operating mode, operational data of the water heating appliance at a second sampling rate.

### FIELD

Embodiments relate to data collection, and more specifically, dynamically collecting data from water heating appliances.

### SUMMARY

Water heating appliances, such as gas-fired water heaters and boilers, are often connected in data acquisition systems. The data acquisition system collects, stores, and transfers various data related to connected devices, such as setpoints, setup parameters, environmental data, installation data, and/or performance data. The data collection rate of such data is commonly a set period or frequency and may be adjusted by an operator of the data acquisition system.

Water heating appliances, however, often experience periods of varying activity. For example, during an ignition (or startup) period, multiple components of the heating appliance work to rapidly heat the water. However, during a period of standby, very little activity may take place. Accordingly, a fixed data collection rate may be insufficient during active periods, causing a loss of valuable data. A fixed data collection rate that is too frequent, however, may result in excess data transfer during a standby period, resulting in an overconsumption of memory and excess data transfer costs.

Embodiments disclosed herein provide systems and methods for dynamically collecting data from water heating appliances. One embodiment provides a water heating system comprising a water heating appliance. The water heating appliance includes a controller having an electronic processor. The controller is configured to receive, in response to the water heating appliance being in a first operating mode, operational data of the water heating appliance at a first sampling rate. The controller is further configured to receive, in response to the water heating appliance being in a second operating mode, operational data of the water heating appliance at a second sampling rate.

In some embodiments, the first operating mode is a startup mode, and the second operating mode is a normal heating operation mode. In some embodiments, the first operating mode is a normal heating operation mode and the second operating mode is a standby mode. In some embodiments, the controller is further configured to receive, in response to detecting the water heating appliance transitioning to a third operating mode, operational data of the water heating appliance at a third sampling rate. In some embodiments, the first sampling rate has a higher frequency than the second sampling rate.

In some embodiments, the water heating appliance is at least one selected from a group consisting of a gas-fired water heater, an electric water heater, a heat pump water heater, a hybrid water heater, a furnace, and a boiler. In some embodiments, the first sampling rate and the second sampling rate are determined by one selected from a group consisting of a user input of a server and a user input of the water heating appliance. In some embodiments, the water heating appliance adjusts at least one selected from a group consisting of the first sampling rate and the second sampling rate based on a fault detection. In some embodiments, a server receives the operational data from the water heating appliance and stores the operational data. In some embodiments, the water heating appliance receives the operational data from one or more sensors.

Another embodiment provides a method for dynamically collecting data from a heating appliance. The method comprises operating, with an electronic controller, the heating appliance in a first operating mode and receiving, from one or more sensors of the heating appliance, operational data regarding the heating appliance at a first sampling rate. The method further includes detecting, with the electronic controller, a transition of the operating mode of the heating appliance from the first operating mode to a second operating mode, adjusting, in response to detecting the transition to the second operating mode, the sampling rate of the operational data to a second sampling rate, and receiving, from the one or more sensors of the heating appliance, the operational data regarding the heating appliance at the second sampling rate.

In some embodiments, the first operating mode is a startup mode, and the second operating mode is a normal heating operating mode. In some embodiments, the first operating mode is a normal heating operating mode, and the second operating mode is a standby mode. In some embodiments, the method further includes detecting, with the electronic controller, a transition of the operating mode of the heating appliance from the second operating mode to a third operating mode, adjusting, in response to detecting the transition to the third operating mode, the sampling rate of the operational data to a third sampling rate, and receiving, from the one or more sensors of the heating appliance, the operational data regarding the heating appliance at the third sampling rate.

In some embodiments, the first sampling rate has a higher frequency than the second sampling rate. In some embodiments, the water heating appliance is at least one selected from a group consisting of a gas-fired water heater, an electric water heater, a heat pump water heater, a hybrid water heater, a furnace, and a boiler. In some embodiments, the first sampling rate and the second sampling rate are determined by one selected from a group consisting of a user input of a server and a user input of the water heating appliance. In some embodiments, adjusting at least one selected from a group consisting of the first sampling rate and the second sampling rate is in response to a fault detection. In some embodiments, a server receives the operational data from the water heating appliance and stores the operational. In some embodiments, a server detects a change in the operating mode of the water heating appliance based on metadata included in the operational data.

Other aspects of the invention will become apparent by consideration of the detailed description and accompanying drawings.

### BRIEF DESCRIPTION OF THE DRAWINGS

FIG. 1 illustrates a data acquisition system, according to some embodiments.

FIG. 2 illustrates a block diagram of a heating appliance of FIG. 1, according to some embodiments.

FIG. 3 illustrates a block diagram of a server of FIG. 1, according to some embodiments.

FIG. 4 illustrates a method of dynamically collecting data from the heating appliance of FIG. 2, according to some embodiments.

FIG. 5 illustrates an additional method of dynamically collecting data from the heating appliance of FIG. 2, according to some embodiments.

FIG. 6 illustrates an additional method of dynamically collecting data from the heating appliance of FIG. 2, according to some embodiments.

### DETAILED DESCRIPTION

Before any embodiments of the invention are explained in detail, it is to be understood that the invention is not limited in its application to the details of construction and the arrangement of components set forth in the following description or illustrated in the following drawings. The invention is capable of other embodiments and of being practiced or of being carried out in various ways.

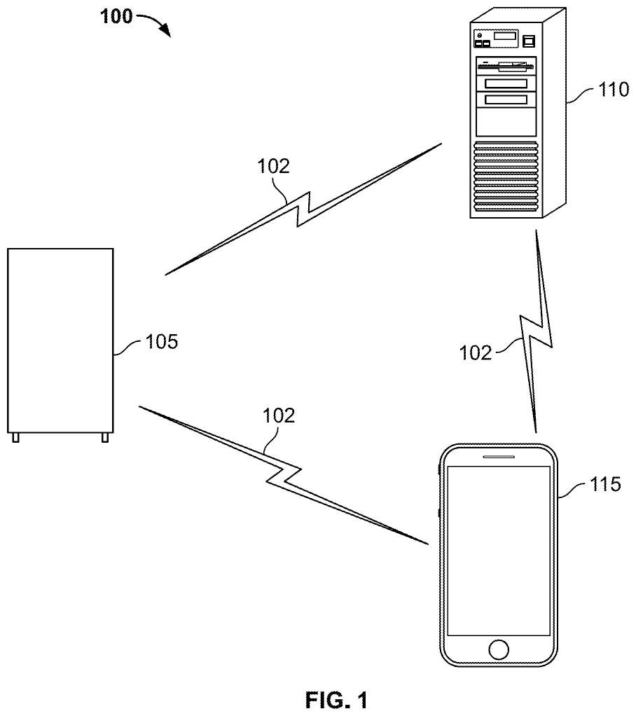

FIG. 1 illustrates a data acquisition system (e.g., water heating system) 100 including a heating appliance 105, a server 110, and a mobile device 115. The heating appliance 105 may be a natural-gas-fueled appliance, a gas-fired water heater, an electric water heater, a boiler, a residential water heater, a residential water tank, a commercial water heater, a commercial water tank, a furnace, a residential furnace, a commercial furnace, a heat pump water heater, a hybrid water heater, or a similar appliance. The heating appliance 105 may be connected to the server 110 and the mobile device 115 via one or more connection(s) 102. The connection 102 may be a wireless connection or a wired connection. For example, the connection 102 may be, but is not limited to, a radio frequency (RF) communication link, a Bluetooth communication link, or a WiFi communication link. In some embodiments, the wireless connection 102 may be part of a local area network (LAN), a neighborhood area network (NAN), a home area network (HAN), or personal area network (PAN). In yet another embodiment, the wireless communication link may be part of a wide area network (WAN) (e.g., the Internet, a TCP/IP based network, a cellular network, such as, for example, a Global System for Mobile Communications [GSM] network, a General Packet Radio Service [GPRS] network, a Code Division Multiple Access [CDMA] network, an Evolution-Data Optimized [EV-DO] network, an Enhanced Data Rates for GSM Evolution [EDGE] network, a 3GSM network, a 4GSM network, a Digital Enhanced Cordless Telecommunications [DECT] network, a Digital AMPS [IS-136/TDMA] network, or an Integrated Digital Enhanced Network [iDEN] network, etc.). In some embodiments, the wired connection 102 is a twisted-pair wire connection, a coaxial cable, an ethernet cable, a fiber-optic cable, or the like.

The server 110 may be configured to store operational data received from the heating appliance 105, described in more detail below. In some embodiments, in addition to being in communication with the heating appliance 105 via the connection 102, the server 110 may also be in communication with the mobile device 115 via the connection 102. The mobile device 115 may be configured to change various settings or operations of the server 110. The mobile device 115 may act in accordance with a received user input. In some embodiments, the mobile device 115 is further configured to communicate with the heating appliance 105. The mobile device 115 may be configured to change various settings or operations of the heating appliance 105.

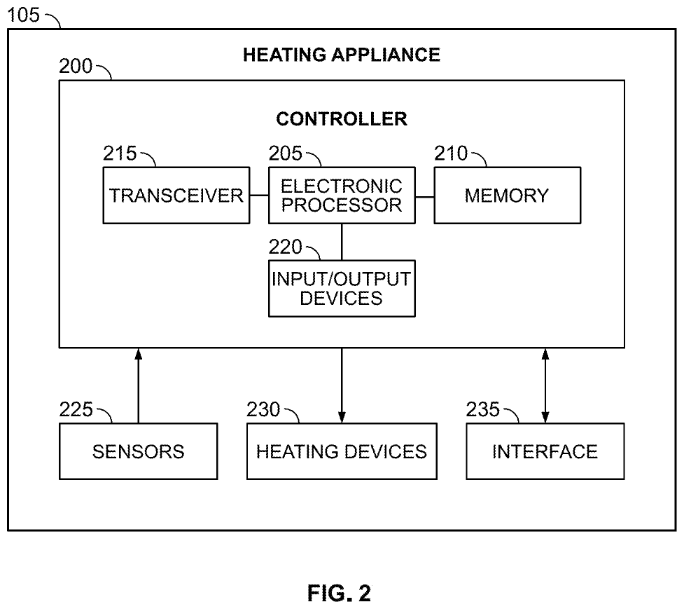

FIG. 2 illustrates a block diagram of the heating appliance 105 according to some embodiments. As illustrated, the heating appliance 105 may include a controller 200, one or more sensors 225, one or more heating devices 230, and an interface 235. The controller 200 includes a plurality of electrical and electronic components that provide power, operational control, and/or protection to the components and modules within the controller 200 and/or the heating appliance 105. For example, the controller 200 may include a first electronic processor 205 (e.g., a microprocessor, a microcontroller, or another suitable programmable device), a memory 210, a first transceiver 215, and input/output devices 220. In some embodiments, the controller 200 is implemented partially or entirely on a printed circuit board or a semiconductor (e.g., a field-programmable gate array [“FPGA”] semiconductor) chip, such as a chip developed through a register transfer level (“RTL”) design process.

The memory 210 may include read only memory (ROM), random access memory (RAM), other non-transitory computer-readable media, or a combination thereof. The first electronic processor 205 is configured to receive instructions and data from the memory 210 and execute, among other things, instructions related to operation of the heating appliance 105. In particular, the first electronic processor 205 may execute instructions stored in the memory 210 to perform the methods described herein.

The input/output devices 220 provide a communication link between the controller 200 and various other components of the heating appliance 105, such as, but not limited to, the one or more sensors 225, the heating devices 230, and the interface 235. The heating devices 230 may be, for example, a burner unit configured to provide a flame for a gas-fueled appliance. The burner unit may produce thermal energy to heat a fluid (for example, water within a tank) using combusted natural gas. In some embodiments, the heating devices 230 may be a plurality of heating elements configured to convert electrical energy to thermal energy. The heating elements may be, for example, an electric resistance heating element.

The one or more sensors 225 provide the controller 200 with data detailing various operations (e.g. operational data) of the heating appliance 105. The one or more sensors 225 may be, for example, a voltage sensor, a current sensor, a temperature sensor, or a combination thereof. In some embodiments, the one or more sensors 225 provide the controller 200 with a signal indicative of a temperature of the water stored by the heating appliance 105. The controller 200 may provide the data received from the one or more sensors 225 with the interface 235. In some embodiments, the controller 200 stores the operational data from the one or more sensors 225 in the memory 210. Upon storing the operational data, the controller 200 may apply a timestamp to one or more samples.

The interface 235 may be a plurality of LEDs or a screen connected to a housing of the heating appliance 105. In some embodiments, the interface 235 provides a current operational status (e.g., operating mode) of the heating appliance 105. The operational status may be, for example, an ignition (or startup) mode, a normal operation mode (e.g., a normal heating operation mode), or a standby mode. In some embodiments, the interface 235 includes a touch screen that accepts touch inputs from a user. A user or operator of the heating appliance 105 may change the operational status of the heating appliance 105 by selecting the desired operational status on the interface 235.

The first electronic processor 205 uses the first transceiver 215 to communicate with at least the server 110 and the mobile device 115. For example, the first transceiver 215 may transmit operational data received from the one or more sensors 225 to the server 110, the mobile device 115, or a combination thereof. The first transceiver 215 may provide the server 110 and the mobile device 115 with operational data. The operational data may be provided by the first transceiver 215 at a set transmission frequency, or at a varying transmission frequency. In some cases, the transmission frequency can vary in response to the variation in the sampling rate. In some embodiments, operational data may be buffered and transmitted as packets. The transmission rate of the packets may also be dependent on the operating mode of the heating appliance 105, as described in more detail below. The transmission rate of the operational data to the server 110 or the mobile device 115 and the sampling rate of the operational data received by the one or more sensors 225 may be independent of each other. Alternatively, in some embodiments, the transmission rate of the operational data is dependent on the sampling rate of the operational data. For example, when operational data is buffered and transmitted as packets, the buffer is filled faster when the sampling rate is higher, resulting in a higher transmission rate. Additionally, the first transceiver 215 may receive data from the server 110 and the mobile device 115. For example, the server 110 or the mobile device 115 may provide the first transceiver 215 with a signal indicative of a change in the sampling rate of the operational data. In some embodiments, the mobile device 115 transmits a request to change in the operating mode of the heating appliance 105. In response to receiving the request to change in the operating mode, the controller 200 adjusts the operating mode of the heating appliance 105. Although FIG. 2 illustrates the heating appliance 105 includes the first transceiver 215, the heating appliance 105 may instead include a transmitter and a receiver separately.

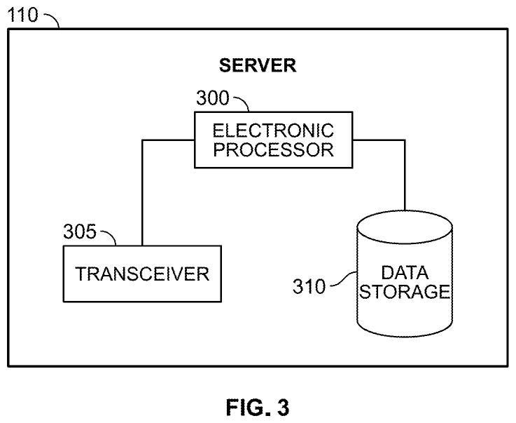

FIG. 3 illustrates a block diagram of the server 110 according to some embodiments. As illustrated, the server 110 may include a second electronic processor 300 (e.g., a second microprocessor, a second microcontroller, or another suitable second programmable device), a second transceiver 305, and a data storage 310. The second transceiver 305 may function in a manner similar to that of the first transceiver 215. The second electronic processor 300 communicates with the heating appliance 105 and the mobile device 115 using the second transceiver 305. Although FIG. 3 illustrates the server 110 including the second transceiver 305, the server 110 may instead include a transmitter and a receiver separately.

The second electronic processor 300 stores operational data received from the heating appliance 105 in the data storage 310. Operational data stored in the data storage 310 may be time-stamped. In some embodiments, the mobile device 115 may request operational data stored in the data storage 310. In response to this request, the second electronic processor 300 transmits operational data to the mobile device 115 using the transceiver 305. In some embodiments, the received operational data may further include metadata detailing the corresponding operating mode of the heating appliance 105 when the operational data was transmitted. As discussed above, the server 110 may receive operational data from the heating appliance 105 at a set sampling rate. In some embodiments, the second electronic processor 300 may detect a change in the operating mode of the heating appliance 105 based on the included metadata. In response to the detected change in the operating mode of the heating appliance 105, the server 110 may transmit a request for a change in the sampling rate.

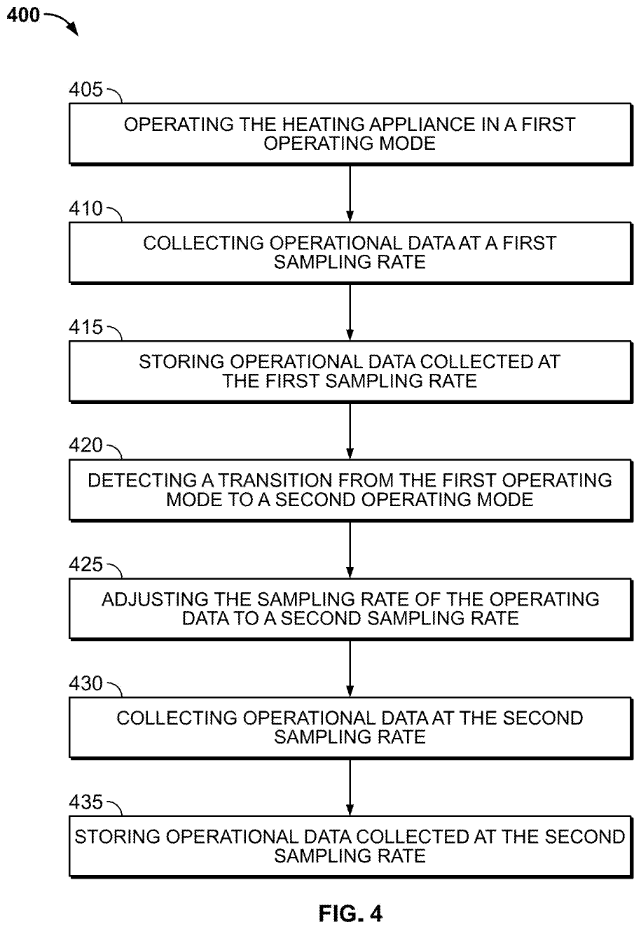

FIG. 4 illustrates a method 400 of dynamically collecting operational data from the heating appliance 105. The method 400 may be performed by the first electronic processor 205, the second electronic processor 300, or a combination thereof. It should be understood that the order of the steps/blocks disclosed in method 400 could vary. Although illustrated as occurring in parallel order, in other embodiments, the steps/blocks disclosed may be performed in a serial order. Furthermore, additional steps/blocks may be added to the process and not all of the steps may be required. At block 405, the method 400 includes operating the heating appliance 105 in a first operating mode. For example, the first operating mode may be an ignition (or startup) mode. During the ignition (or startup) mode, the heating appliance 105 may heat water from a storage temperature to a first temperature. In some embodiments, the first operating mode is a normal operation mode. During the normal operation mode, the heating appliance 105 maintains the water at a specified operation temperature. In some embodiments, the first operating mode is a standby mode. During the standby mode, the heating appliance 105 may be in a substantially “OFF” state. The heating appliance 105 may report operational data while in standby mode, but does not heat the water. In some embodiments, during the standby mode, the heating appliance 105 maintains the water at a temperature lower than the operation temperature.

At block 410, the method 400 includes collecting operational data at a first sampling rate (e.g., a first sampling frequency). The first sampling rate may be a sampling rate corresponding to the first operating mode. For example, if the first operating mode is the ignition (or startup) mode, the first sampling rate may be once every second. In some embodiments, if the first operating mode is the ignition (or startup) mode, the first sampling rate is at a frequency of once per milliseconds. Should the first operating mode be the normal operation mode, the first sampling rate may be once every minute, or once every ten minutes. In some embodiments, when the first operating mode is the standby mode, the first sampling rate is one selected from a group consisting of once every 30 minutes, once every hour, or once every several hours. Each of these sampling rates are merely examples and may be altered to fit the needs of the operator of the heating appliance 105.

At block 415, the method 400 includes storing the operational data collected at the first sampling rate. For example, the controller 200, after collecting operational data from the one or more sensors 225, stores the operational data in the memory 210. In some embodiments, each stored operational data sample is time-stamped. In some embodiments, the stored operational data may be transmitted to the server 110 using the first transceiver 215 in accordance with a transmission frequency as detailed above. In some embodiments, the first transceiver 215 transmits the operational data to the mobile device 115. The operational data may be transmitted at the same rate as the first sampling rate. In other embodiments, the first transceiver 215 transmits packets of operational data to the server 110.

At block 420, the method 400 includes detecting a transition from the first operating mode to a second operating mode. For example, the heating appliance 105 may transition from the ignition (or startup) mode to the normal operation mode. The transition from the ignition (or startup) mode to the normal operation mode may occur in response to the temperature of the water reaching the operational temperature. The heating appliance 105 may transition from the normal operation mode to the standby mode. The heating appliance 105 may transition from the standby mode to the ignition (or startup) mode. In some embodiments, the heating appliance 105 transitions from the ignition (or startup) mode to the standby mode. In some embodiments, the transition from the first operating mode to the second operating mode occurs due to an input received via the interface 235 or the mobile device 115. Detecting the transition from the first operating mode to the second operating mode may be based on the metadata included in the operational data. For example, the server 110 may detect the second operating mode based on the metadata, as detailed above.

At block 425, the method 400 includes adjusting the sampling rate of the operational data to a second sampling rate. Upon changing from the first operating mode to the second operating mode, the first electronic processor 205 may adjust the sampling rate to a sampling rate that corresponds to the second operating mode. For example, if the operating mode transitions from the ignition (or startup) mode to the normal operating mode, the sampling rate changes from once every second to once every minute. In another example, if the operating mode transitions from the normal operating mode to the standby mode, the sampling rate changes from once every minute to once every thirty minutes. Accordingly, in some embodiments, the first sampling rate is at a higher (e.g., greater) frequency than the second sampling rate. However, the heating appliance 105 is not restricted to only these examples.

In some embodiments, the controller 200, and/or the first electronic processor 205, adjusts the sampling rate of the operational data to the second sampling rate when the controller 200 transitions the heating appliance 105 from the first operating mode to the second operating mode. In some embodiments, the controller 200 receives a request to adjust the sampling rate of the operational data from the server 110. For example, upon detecting the second operating mode based on the metadata, the server 110 generates a request to adjust the sampling rate of the operational data. The server 110 transmits the request to the controller 200 using the second transceiver 305.

In some embodiments, the controller 200 receives a request to adjust the sampling rate of the operational data from the mobile device 115. For example, a user of the mobile device 115 inputs, using the touchscreen, a request to adjust the sampling rate for a given operational mode. If the operational mode is the normal operation mode, for example, the user may request to adjust the associated sampling rate from once every minute to once every two minutes. In some embodiments, an operator (e.g., user) of the server 110 inputs a request to adjust the sampling rate for the given operational mode.

In some embodiments, the sampling rate is adjusted based on a fault condition (e.g., a fault detection). For example, in some embodiments, at least one selected from a group consisting of the first sampling rate and the second sampling rate are adjusted based on a fault condition. The fault condition may be an over-temperature condition, a failure of one of the heating devices 230, an over-voltage condition, an over-current condition, or the like.

At block 430, the method 400 includes collecting operational data at the second sampling rate. The second sampling rate may be a sampling rate corresponding to the second operating mode, as previously described with respect to the first sampling rate. At block 435, the method 400 includes storing the operational data collected at the second sampling rate. In some embodiments, the stored operational data may be transmitted to the server 110 using the first transceiver 215 in accordance with a transmission frequency as detailed above. The operational data may be transmitted at the same rate as the second sampling rate. In other embodiments, the first transceiver 215 transmits packets of operational data to the server 110.

In some embodiments, the heating appliance 105 transitions to a third operating mode. Accordingly, the method 400 may include detecting a transition from the second operating mode to the third operating mode. For example, the heating appliance 105 may transition from a first operating mode of the ignition (or startup) mode, to a second operating mode of the normal operating mode, to a third operating mode of the standby mode. The method 400 may further include adjusting the sampling rate of the operational data to a third sampling rate. For example, the first electronic processor 205 (or, in some embodiments, the second electronic processor 300), upon detecting the transition to the third operating mode, adjusts the sampling rate of the operational data to the corresponding third sampling rate. The method 400 may further include collecting the operational data at the third sampling rate.

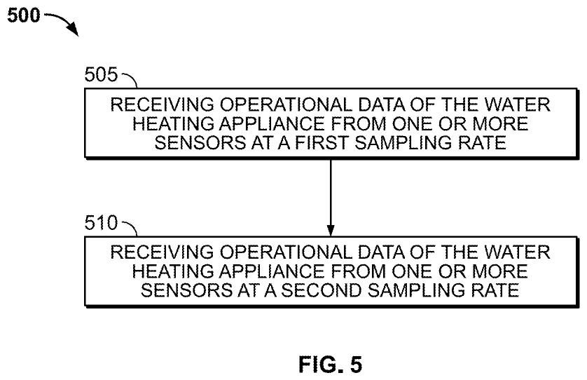

FIG. 5 illustrates a method 500 performed by the controller 200 according to another embodiment. It should be understood that the order of the steps/blocks disclosed in method 500 could vary. Although illustrated as occurring in serial order, in other embodiments, the steps/blocks disclosed may be performed in a parallel order. Furthermore, additional steps/blocks may be added to the process and not all of the steps may be required. At block 505, the controller 200 receives, in response to the heating appliance 105 being in the first operating mode, the operational data of the heating appliance 105 from the one or more sensors 225 at a first sampling rate. For example, as described above, each operating mode of the heating appliance 105 has an associated sampling rate. The controller 200 collects operational data at the sampling rate of the corresponding operating mode. At block 510, the controller 200 receives, in response to the heating appliance 105 being in the second operating mode, the operational data of the heating appliance 105 from the one or more sensors 225 at the second sampling rate. For example, as described above, the heating appliance 105 may transition to an additional operating mode, such as transitioning from an ignition (or startup) mode to a normal operating mode. When the heating appliance 105 transitions operating modes, the controller 200 adjusts the sampling rate to a second sampling rate. Accordingly, the controller 200 collects operational data at the sampling rate of the corresponding second operating mode.

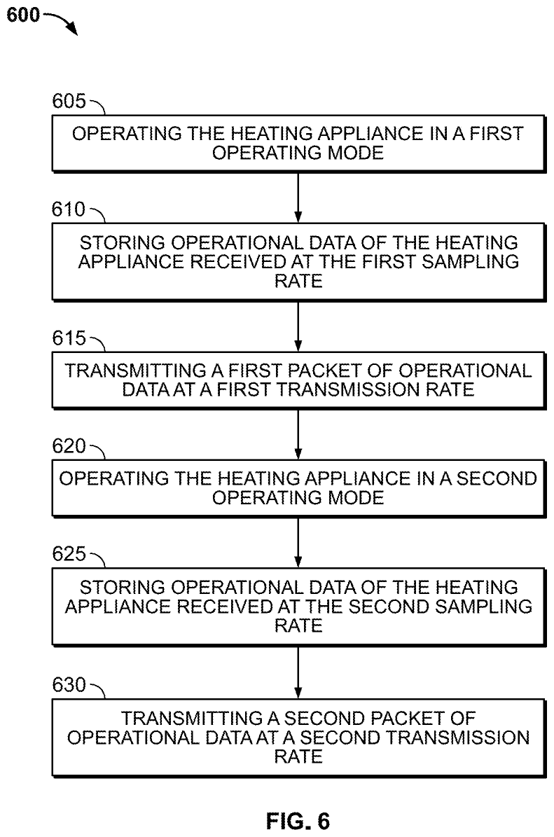

In some embodiments, to minimize the number of transmissions to the server 110 and/or the mobile device 115, the heating appliance 105 transmits the operational data as packets of data. For example, FIG. 6 illustrates a method 600 performed by the controller 200 according to another embodiment. It should be understood that the order of the steps/blocks disclosed in method 600 could vary. Although illustrated as occurring in serial order, in other embodiments, the steps/blocks disclosed may be performed in a parallel order. Furthermore, additional steps/blocks may be added to the process and not all of the steps may be required.

At block 605, the controller 200 operates the heating appliance 105 in a first operating mode, as previously described. At block 610, the controller 200 stores operational data of the heating appliance 105 received at the first sampling rate, as previously described. For example, the operational data may be stored in the memory 210. Each sample of operational data may include a timestamp indicating when the sample was measured and/or stored. At block 615, the controller 200 transmits a first packet of operational data at a first transmission rate. For example, the controller 200 creates a first packet of operational data using a plurality of samples of operational data. The packet may be composed of all samples of operational data within a given timeframe. In some embodiments, the samples of operational data are stored in a buffer of the memory 210. The samples of operational data stored in the buffer are then transmitted by the controller 200 as a packet of operational data when the buffer is filled.

At block 620, the controller 200 operates the heating appliance 105 in a second operating mode, as previously described. At block 625, the controller 200 stores operational data of the heating appliance 105 received at the second sampling rate, in a similar manner as in block 610. At block 630, the controller 200 transmits a second packet of operational data at a second transmission rate. For example, the controller 200 transmits the second packet of operational data to the server 110 and/or the mobile device 115. In some embodiments, the second sampling rate is different from the first sampling rate due to an increase or decrease in the sampling rate, based on the second operating mode. For example, should the heating appliance 105 transition from the ignition mode to the normal operation mode, the sampling rate of the operational data decreases. The amount of time it takes for the buffer to fill increases, reducing the transmission rate. Should the heating appliance 105 transition from the standby mode to the ignition mode, however, the sampling rate of the operational data increases. Accordingly, the amount of time it takes for the buffer to fill decreases, increasing the transmission rate. By transmitting packets of operational data at varying sampling rates, the controller 200 minimizes the number of transmissions conducted, while still transmitting the same amount of operational data.

Thus, embodiments provide, among other things, systems and methods for dynamically collecting data from water heating appliances. Various features and advantages are set forth in the following claims.

What is claimed is:

1. A water heating system comprising:
a water heating appliance, the water heating appliance including a controller having an electronic processor, the controller configured to:
receive, in response to the water heating appliance being in a first operating mode, operational data of the water heating appliance at a first sampling rate; and
receive, in response to the water heating appliance being in a second operating mode, operational data of the water heating appliance at a second sampling rate.

2. The water heating system of claim 1, wherein the first operating mode is a startup mode, and wherein the second operating mode is a normal heating operation mode.

3. The water heating system of claim 1, wherein the first operating mode is a normal heating operation mode, and wherein the second operating mode is a standby mode.

4. The water heating system of claim 1, wherein the controller is further configured to:
receive, in response to detecting the water heating appliance transitioning to a third operating mode, operational data of the water heating appliance at a third sampling rate.

5. The water heating system of claim 1, wherein the first sampling rate has a higher frequency than the second sampling rate.

6. The water heating system of claim 1, wherein the water heating appliance is at least one selected from a group consisting of a gas-fired water heater, an electric water heater, a heat pump water heater, a hybrid water heater, a furnace, and a boiler.

7. The water heating system of claim 1, wherein the first sampling rate and the second sampling rate are determined by one selected from a group consisting of a user input of a server and a user input of the water heating appliance.

8. The water heating system of claim 1, wherein the water heating appliance adjusts at least one selected from a group consisting of the first sampling rate and the second sampling rate based on a fault detection.

9. The water heating system of claim 1, wherein a server receives the operational data from the water heating appliance and stores the operational data.

10. The water heating system of claim 1, wherein the water heating appliance receives the operational data from one or more sensors.

11. A method for dynamically collecting data from a heating appliance, the method comprising:
operating, with an electronic controller, the heating appliance in a first operating mode;
receiving, from one or more sensors of the heating appliance, operational data regarding the heating appliance at a first sampling rate;
detecting, with the electronic controller, a transition of the operating mode of the heating appliance from the first operating mode to a second operating mode;
in response to detecting the transition to the second operating mode, adjusting the sampling rate of the operational data to a second sampling rate; and
receiving, from the one or more sensors of the heating appliance, the operational data regarding the heating appliance at the second sampling rate.

12. The method of claim 11, wherein the first operating mode is a startup mode, and wherein the second operating mode is a normal heating operating mode.

13. The method of claim 11, wherein the first operating mode is a normal heating operating mode, and wherein the second operating mode is a standby mode.

14. The method of claim 11, further comprising:
detecting, with the electronic controller, a transition of the operating mode of the heating appliance from the second operating mode to a third operating mode;
in response to detecting the transition to the third operating mode, adjusting the sampling rate of the operational data to a third sampling rate; and
receiving, from the one or more sensors of the heating appliance, the operational data regarding the heating appliance at the third sampling rate.

15. The method of claim 11, wherein the first sampling rate has a higher frequency than the second sampling rate.

16. The method of claim 11, wherein the heating appliance is at least one selected from a group consisting of a gas-fired water heater, an electric water heater, a heat pump water heater, a hybrid water heater, a furnace, and a boiler.

17. The method of claim 11, wherein the first sampling rate and the second sampling rate are determined by one selected from a group consisting of a user input of a server and a user input of the water heating appliance.

18. The method of claim 11, wherein adjusting at least one selected from a group consisting of the first sampling rate and the second sampling rate is in response to a fault detection.

19. The method of claim 11, wherein a server receives the operational data from the heating appliance and stores the operational data.

20. The method of claim 11, wherein a server detects a change in the operating mode of the heating appliance based on metadata included in the operational data.
